(19) United States
(12) Patent Application Publication
(10) Pub. No.: US 2014/0285526 A1
(43) Pub. Date: Sep. 25, 2014

(54) APPARATUS AND METHOD FOR MANAGING LEVEL OF DETAIL CONTENTS

(71) Applicant: KOREA INSTITUTE OF SCIENCE AND TECHNOLOGY, Seoul (KR)

(72) Inventors: Heedong KO, Seoul (KR); Hyoung Gon KIM, Seoul (KR); Sangchul AHN, Seoul (KR); Byounghyun YOO, Seoul (KR); Hogun PARK, Daegu (KR); Daeil SEO, Seoul (KR)

(73) Assignee: KOREA INSTITUTE OF SCIENCE AND TECHNOLOGY, Seoul (KR)

(21) Appl. No.: 14/215,137

(22) Filed: Mar. 17, 2014

(30) Foreign Application Priority Data
Mar. 20, 2013 (KR) 10-2013-0029617

(51) Int. Cl. G06T 3/40

(52) U.S. Cl. CPC G06T 3/40
USPC 345/660

(57) ABSTRACT

Disclosed is a method and apparatus for managing content media. The method for managing content media includes creating or receiving content media, receiving level of detail (LOD) setting information at which the content media is displayed, and determining a display format of a point of interest (POI) on the content media based on the LOD setting information.

### CROSS-REFERENCE TO RELATED APPLICATION

This application claims priority to Korean Patent Application No. 10-2013-0029617 filed on Mar. 20, 2013, and all the benefits accruing therefrom under 35 U.S.C. §119, the contents of which in its entirety are herein incorporated by reference.

### BACKGROUND

1. Field

Exemplary embodiments relate to an apparatus and method for managing content media, and more particularly, to an apparatus and method for managing content media with an emphasis on convenience of a user.

2. Description of the Related Art

With the development of smart devices such as smart phones and smart pads, information related to content media including a map is provided through smart devices, and there is a growing demand for a user-customized service to provide a competitive content media service. On content media, Points of Interest (POIs) are displayed. For example, a POI corresponds to latitude and longitude coordinates in a partial map application or the like.

FIG. 1 is an example view showing a POI according to a related art. In a conventional application, too many POIs are displayed at once in response to a search query through a keyword ‘restaurants in Seoul’, as known empirically, which makes it difficult for an ordinary user to make a decision with only the keyword ‘restaurant’. The user can only find a nearby restaurant by zooming in a map to a desired destination. Also, FIG. 2a is a view showing Gyeongbokgung (palace) as a POI in accordance with a representation technology of a conventional map application, and FIG. 2b is a view showing Gyeonghoeru (pavilion) within Gyeongbokgung as a POI. Gyeongbokgung includes Gyeonghoeru, Jagyeongjeon (hall), Sajeongjeon (hall), and the like.

Referring to FIGS. 2a and 2b, Gyeonghoeru is included in Gyeongbokgung but an inclusion relation for each POI is not depicted, and Gyeonghoeru of FIG. 2b is just illustrated on the same level as Gyeonghoeru shown in FIG. 2a. That is, there are problems that only scale information of a map application is insufficient to display a suitable POI and it is not feasible to depict an inclusion relation for each POI, as a consequence, efficient transmission of map information to a user is not yet achieved.

### RELATED LITERATURES

### Patent literature

(Patent Literature 1) Korean Patent Publication No. 10-2011-0060535

### SUMMARY

According to one aspect, necessary information may be properly provided to a user based on Level of Detail (LOD) information of a user context.

According to another aspect, a Point of Interest (POI) on a map may be provided to a user in three dimensions by depicting an inclusion relation between a plurality of POIs.

According to still another aspect, necessary information may be provided to a user by processing information of a POI at a proper granularity based on LOD information of a user context.

According to one aspect, there is provided a method for managing content media including creating or receiving content media, receiving LOD setting information at which the content media is displayed, and determining a display format of a POI on the content media based on the LOD setting information.

According to another aspect, there is provided a computer-readable recording medium having stored therein a program for causing a computer to execute a method for managing content media, including creating or receiving content media, receiving LOD setting information at which the content media is displayed, and displaying a POI on the content media based on the LOD setting information.

According to still another aspect, there is provided an apparatus for managing content media including a content media management unit to create or receive content media, an information granularity management unit to receive LOD setting information at which the content media is displayed, and a display format determination unit to determine a display format of a POI on the content media based on the LOD setting information.

According to one aspect, suitable information for LOD information of a map that indicates how minutely a user reads the map may be effectively provided. Then, the user may obtain various information while zooming in or out the map.

According to another aspect, among a plurality of POls displayed based on LOD information of a user context, it is possible to identify whether some of them are included in one another or not, and thus, there is an effect that a user can identify the POIs on a map in three dimensions.

According to still another aspect, content media may be displayed in a format suited for user needs by processing the content media at a proper granularity based on LOD information of a user context, so that a user may obtain information in a most proper format for the user context.

### BRIEF DESCRIPTION OF THE DRAWINGS

FIGS. 1 through 2B are views showing an example of a Point of Interest (POI) displayed on a map application according to a related art.

FIG. 3A is a diagram illustrating a relationship between an apparatus for managing content media and a client terminal according to an exemplary embodiment.

FIG. 3B is a detailed diagram illustrating an internal construction of an apparatus for managing content media according to an exemplary embodiment.

FIG. 4 is a diagram illustrating an example of levels at which content media is represented at various granularity.

FIG. 5 is a diagram illustrating an example of levels at which an identical content media is represented at varying granularity based on a context of a user.

FIG. 6A is a diagram illustrating an example of levels at which content media including information of a POI displayable on a map is represented at varying granularity based on a context of a user with respect to a particular interest of the user.

FIG. 6B is a diagram illustrating an example of levels at which content media including information of a POI displayable on a map is represented at varying granularity based on a context of a user with respect to another particular interest of the user.

FIGS. 7A-7E illustrate a display of a map application represented by a method for managing content media based on a level of detail (LOD) of a map according to an exemplary embodiment.

FIGS. 8A-8E illustrate a display of a map application represented by a method for managing content media at varying granularity based on a degree of interest of a user according to an exemplary embodiment.

FIGS. 9A through 9C are views illustrating a display of a map application represented by a method for managing content media according to an exemplary embodiment.

FIGS. 10, 11A, and 11B are diagrams illustrating examples of geohash according to an exemplary embodiment.

FIG. 12 is a flowchart illustrating a method for managing content media according to an exemplary embodiment.

FIG. 13 is a flowchart illustrating a method for managing content media according to another exemplary embodiment.

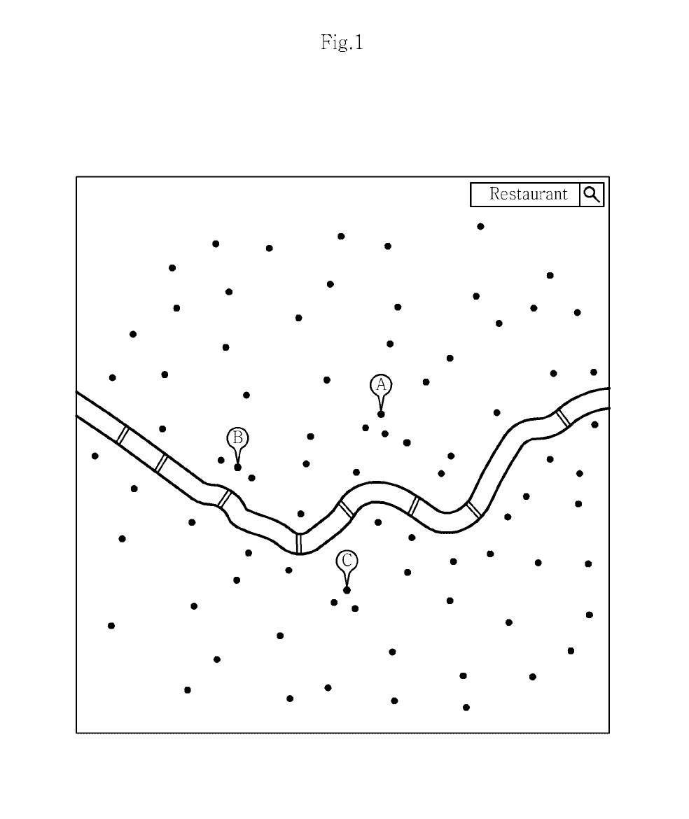

### DETAILED DESCRIPTION

Exemplary embodiments now will be described more fully hereinafter with reference to the accompanying drawings, in which particular embodiments by which the present disclosure may be practiced are shown for illustration. These exemplary embodiments are described in enough detail for those skilled in the art to practice the present disclosure. It should be understood that various embodiments of the present disclosure are different but do not need to be mutually exclusive. For example, a particular shape, structure, and feature stated herein may be implemented as other embodiment within the spirit and scope of the present disclosure in relation to one embodiment. Also, it should be understood that a location or placement of an individual component in each embodiment disclosed herein may be changed without departing from the spirit and scope of the present disclosure. Therefore, the following detailed description is not intended to be construed as limitative meaning, and the scope of the present disclosure is confined, if properly explained, only by the accompanying claims together with all the equivalents thereto. In the drawings, like reference numerals indicate identical or similar functions throughout many aspects.

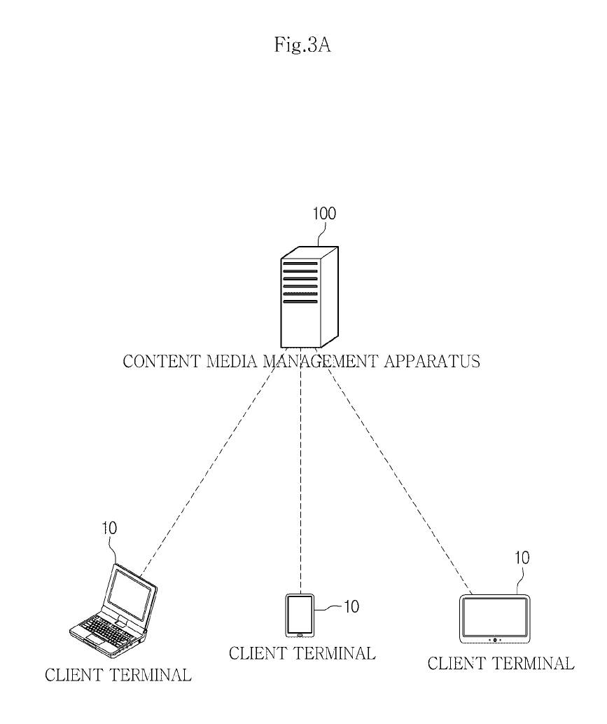

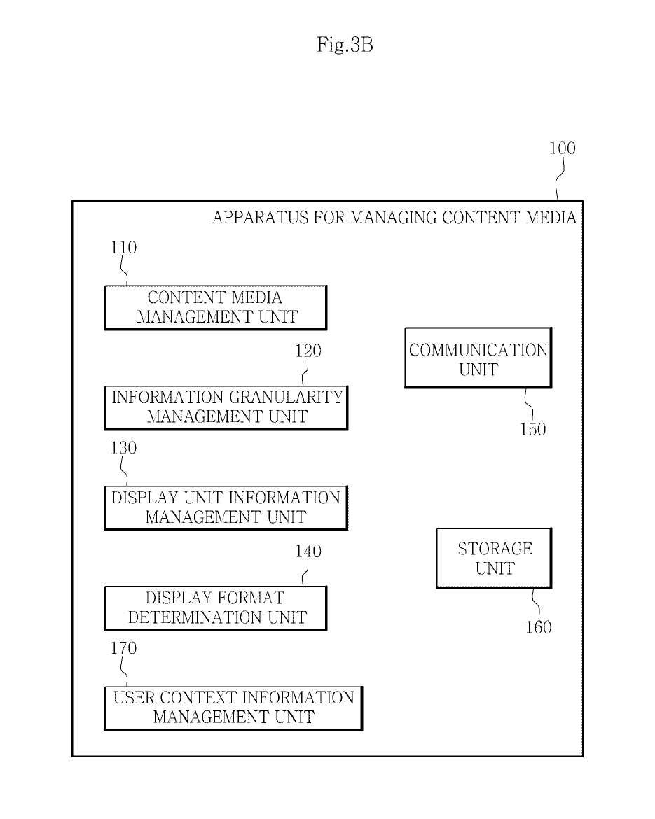

FIG. 3a is a diagram illustrating a relationship between an apparatus 100 for managing content media and a client terminal 10 according to an exemplary embodiment.

The apparatus 100 for managing content media is an apparatus that provides a service to allow the client terminal 10 to display content media information through communication with the client terminal 10 via a network. In one embodiment, the apparatus 100 for managing content media may be a type of a server. A detailed description of the apparatus 100 for managing content media will be provided below through FIG. 3b.

The client terminal 10 is a terminal that a client uses. The client may identify content media by communication with the apparatus 100 for managing content media through the client terminal 10. On the content media, a point of interest (POI) described in the foregoing may be displayed. Here, the content media may include content information and Level of Detail (LOD) setting information.

The content information may include information associated with a location such as a map, a picture, a video, a text, and the like.

The term ‘LOD’ used herein refers to a degree to which particular information is represented in detail. Also, in one embodiment, when the particular information is content media for a map, a LOD may be a scale ratio. That is, a LOD may include a ‘scale ratio’.

The apparatus 100 for managing content media stores full detailed information for content information to represent various LODs based on information granularity requested from the client, and in response to a request from an application, may provide the client with content information in a format suited for a corresponding level through the client terminal 10. For convenience of description, the description will be provided based on a map as the content media. The client may transmit LOD setting information, at which the content media is displayed through the client terminal 10, to the apparatus 100 for managing content media through the client terminal 10. The LOD setting information is information that represents a LOD at which the content media is displayed. Based on the LOD, the content media is provided to the client terminal 10 in various formats.

For example, the lower the LOD setting information in a map application, a lower-level content media (that is, detailed map information) may be identified.

The client may change the LOD setting information numerically, but may provide LOD information by inputting (touching or dragging) a particular area of a display unit of the client terminal 10. For example, the client may change LOD information to display a particular area on a full screen of the display unit by selecting the corresponding area displayed on the screen.

The client may transmit information of the display unit of the client terminal 10 through the client terminal 10. The display unit information is information associated with a resolution and a horizontal size and a vertical size of the display unit on which the client terminal 10 is displayed. Even though LOD setting information is identical, if a resolution or size of the display unit is different, a different user experience is transmitted from a user, hence, in consideration of display unit information along with LOD setting information, content media information appropriate therefor should be displayed.

The client may transmit user context information of the client terminal 10 through the client terminal 10. The user context information may include information including, for example, user location information, movement direction information, an experience history, and the like. Even though LOD setting information is identical, if information of a user location and a movement direction is different, a different user experience is transmitted from a user, hence, in consideration of a user context in an in-situ situation along with LOD setting information, content media information appropriate therefor should be displayed.

In one example, the apparatus for managing content media may adjust the display of the content media information in consideration of display unit information and user context information together.

The client terminal 10 may be implemented in various types, and may include various features. The client terminal 10 may include all devices capable of running a particular application, and is not limited to a specific type. In one embodiment, an application or any program may be run through the client terminal 10, and may use a camera function, a storage function, and a computation function of the client terminal 10. For example, the client terminal 10 includes all handheld radio terminals such as a Personal Communication System (PCS), a Global System for Mobile communications (GSM), a Personal Digital Cellular (PDC), a Personal Handyphone System (PHS), a Personal digital Assistant (PDA), an International Mobile Telecommunications-2000 (IMT-2000) based terminal, and the like. Also, the client terminal 10 may include a processing system equipped with a processor, an operating system, and an Application Program Interface (API) to provide communication between at least one software application and an operating system. Further, the processing system of the client terminal 10 may be configured to execute various software applications.

The client terminal 10 may communicate with an object, and to do so, may have hardware or software mounted thereon. A communication method may include all communication methods that enable networking between objects, and is not limited to wired/wireless communication, third Generation (3G), 4G, or other methods.

FIG. 3b is a detailed diagram illustrating an internal construction of the apparatus 100 for managing content media according to an exemplary embodiment. The apparatus 100 for managing content media may include a content media management unit 110, an information granularity management unit 120, a display unit information management unit 130, a display format determination unit 140, a communication unit 150, and a storage unit 160. In other embodiment, the content media management apparatus 100 may further include a user context information management unit 170.

The content media management unit 110 serves to create or receive content media. In the content media, an above-described POI may be displayed on content as described in the foregoing. Here, the content may include any content containing information associated with a location such as a map, a picture, a video, and the like. The content media may be already stored in the storage unit 160, or may be received from an external object (not shown) via a network. A communication method may include all types of general communications, and is not particularly limited.

The information granularity management unit 120 serves to receive LOD setting information at which the content media is displayed. In one embodiment, the LOD setting information may be basically set. Even though the information granularity management unit 120 does not receive LOD setting information from the client terminal 10 or the external object, the information granularity management unit 120 may receive the basic LOD setting information stored in the storage unit 160 and display the content media at the corresponding LOD setting information. In other embodiment, the information granularity management unit 120 may receive, from the client terminal 10, LOD setting information at which the content media is displayed. As described in the foregoing, the information granularity management unit 120 may receive LOD setting information numerically from the client terminal 10, but the information granularity management unit 120 may receive area information by a touch or drag input, and calculate LOD setting information at which the area information may be properly displayed.

A content media may be configured to be displayed at various information granularity as shown in FIG. 4. In FIG. 4, a block may denote a LOD.

The LOD may be plural based on information granularity, and as shown in FIG. 4, a topic may be set in a top level, and a summary as a subordinate concept of the topic may be set in a level next thereto. Also, a more detailed content of a lower level may be set in a level next thereto.

That is, in one embodiment, a highest LOD at which only minimum information is displayed allows only a content corresponding to a topic to be displayed, and when maximum information is displayed at a lowest LOD, information is provided at such a LOD to include all contents media related to the topic and their additional description (various enriched content media with full detailed description) together. Here, the additional description may be information included in the corresponding content media.

A content media may differ in a display format based on various LOD levels between a most summarized LOD (a highest LOD level) and a most detailed LOD (a lowest LOD level).

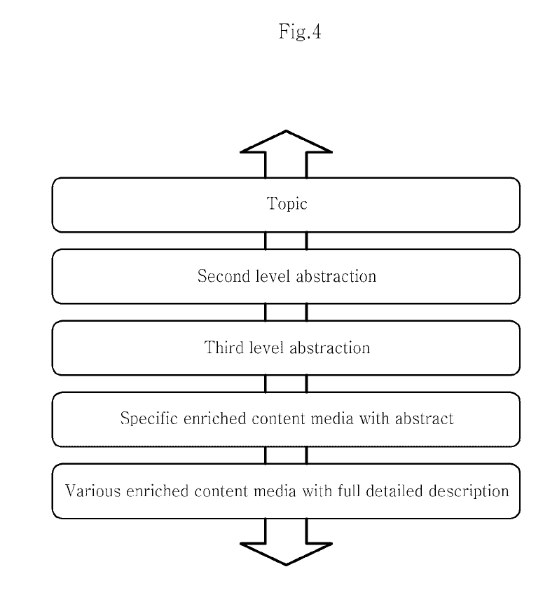

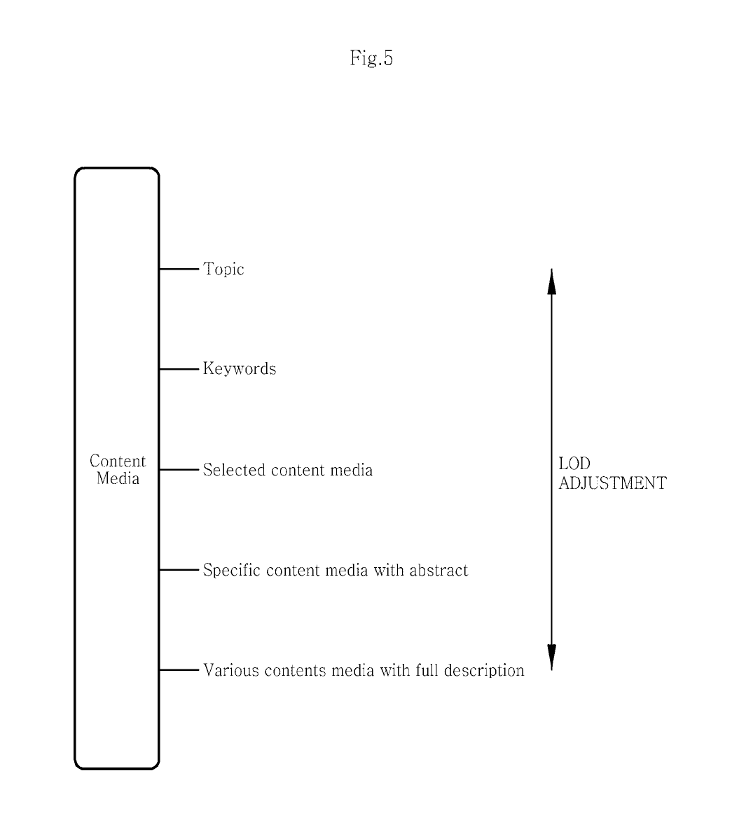

The information granularity management unit 120 serves to determine a LOD at which the content media is displayed. In one embodiment, a basic value for the LOD of the content media may be set. Even though the information granularity management unit 120 does not receive LOD setting information from the client terminal 10 or the external object, the information granularity management unit 120 may receive basic LOD information stored in the storage unit 160 and display a detailed content media at corresponding LOD setting information. As described in the foregoing, the LOD information may be also received numerically from the client terminal 10. FIG. 5 is a conceptual diagram illustrating a function of the information granularity management unit 120 of adjusting a format of content media. The information granularity management unit 120 may adjust a granularity of content media from minimum information to maximum information in response to a request from a user as shown in FIG. 5, and content media has full detailed information to allow the content media to be displayed at various levels, and accordingly, the information granularity management unit 120 may represent content media in a format of other granularity without receiving the content media again.

As a context of a user is reflected in different respects based on a particular interest of the user, a content media is displayed at various granularity. An example of granularity determined based on a particular interest of a user may include a level of interest. The term ‘level of interest’ used herein refers to an extent to which a particular interest is detailed. Also, in one embodiment, when an interest of a user is a basis of a LOD, a LOD may be a level of interest.

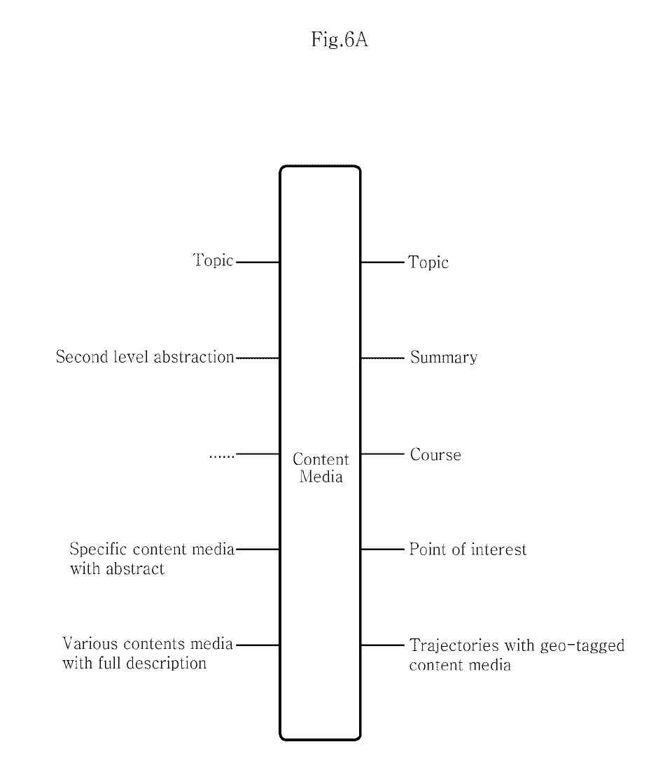

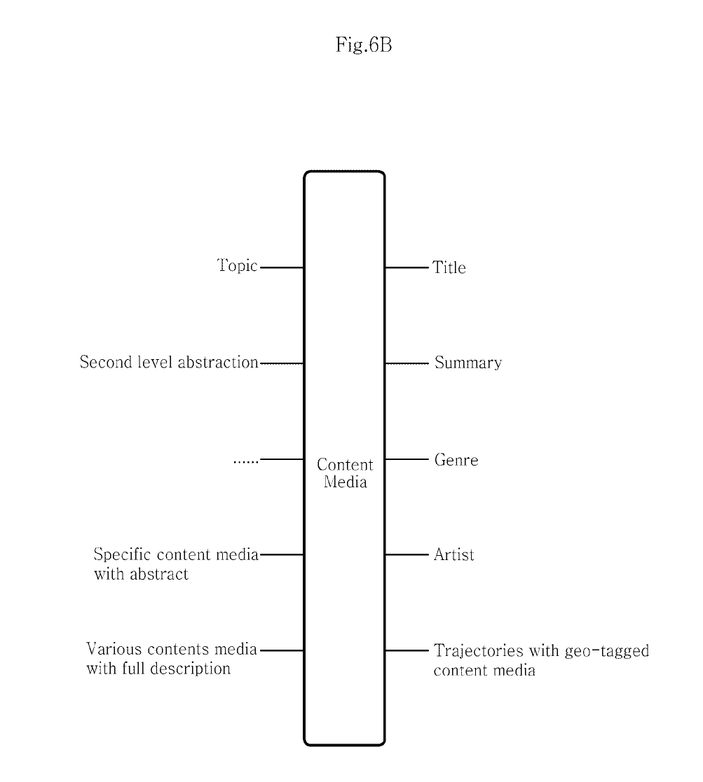

FIG. 6a and FIG. 6b illustrate an embodiment of a level of interest, and various levels of interest may be defined based on a perspective of a user, a level of interest of a user may be represented using only one level of interest, or may be simultaneously or independently represented by selectively combining various levels of interest, and an embodiment of the level of interest is not limited to the above embodiments. In FIG. 6a, an exemplary definition for each LOD of content media based on information granularity is provided at the left side of the content media, and an exemplary content of travel information corresponding to each definition is provided at the right side. As an embodiment of content media, travel information described as content media including various types of location information is provided at such a granularity to include a movement route, each detailed content media, and even their additional description together, when displaying maximum information. In the display at a less detailed level of granularity, a POI included in the content media and a representative content media may be displayed in a summarized format, and in the display at a more summarized level, course information made up of POls may be displayed in a summarized format. In the display at a highest granularity where an outline of a highest level of summarization is displayed, the travel information described as the same content media may be displayed as only a topic and representative location information or area information of the content media, and in the display of a detailed level of granularity, only summarized information of the content media may be displayed.

In FIG. 6b, an exemplary definition for each LOD of content media based on information granularity is provided at the left side of the content media, and an exemplary content viewed with a different interest in the content media is provided at the right side. In FIG. 6a, information granularity of the content media is determined by an interest of a viewpoint of travel, but for the same content media, FIG. 6b shows an exemplary disclosure in which information granularity is determined based on an interest in a work. As an embodiment of content media, similar to the above content media display, information is provided at such a granularity to include a movement route, each detailed content media, and even their additional description together, when displaying maximum information. In the display at a less detailed level of granularity, information allowing categorization of the content media by artist may be displayed in a summarized format, and in the display at a more summarized level, a genre including an artist may be displayed in a summarized format. In the display at a highest granularity where information summarized at a highest level is displayed, only a title of the content media may be displayed, and in the display of a more detailed level of granularity, only summarized information of the content media may be displayed.

The user context information management unit 170 serves to manage user context information, including, for example, user location information, movement direction information, an experience history, and the like. The display unit information management unit 130 serves to receive display unit information of the client terminal from the client terminal 10. In one embodiment, the display unit information management unit 130 may receive display unit information that has been received from the client terminal 10 and stored in the storage unit 160. As described in the foregoing, the display unit information is information associated with a resolution and a horizontal size and a vertical size of the display unit on which the client terminal 10 is displayed. Even though LOD setting information is identical, when user context information in an in-situ situation such as user location information, movement direction information, and an experience history, and a resolution or a size of the display unit are different, a different user experience is transmitted from a user, and thus, in consideration of a user context and display unit information along with LOD setting information, content media information appropriate therefor should be displayed.

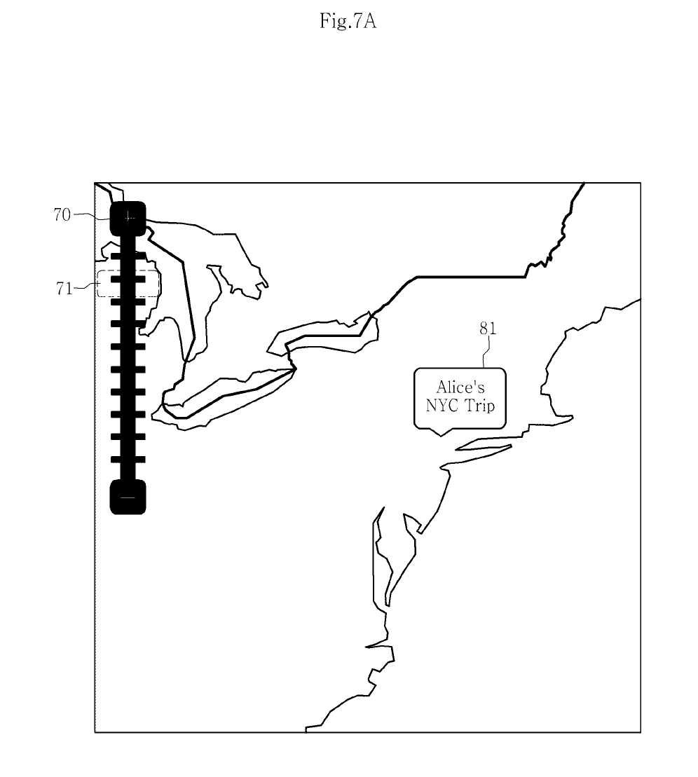

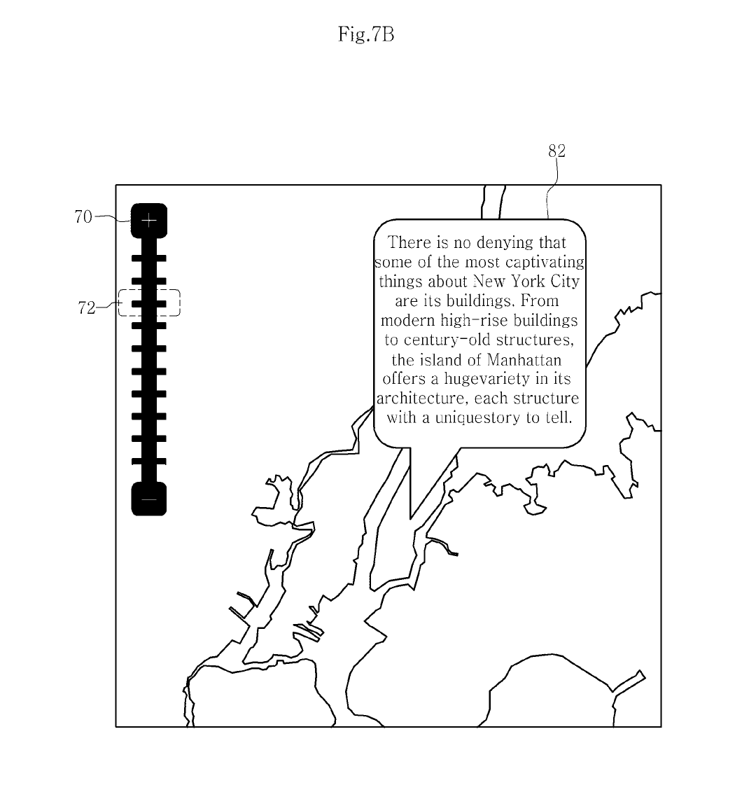

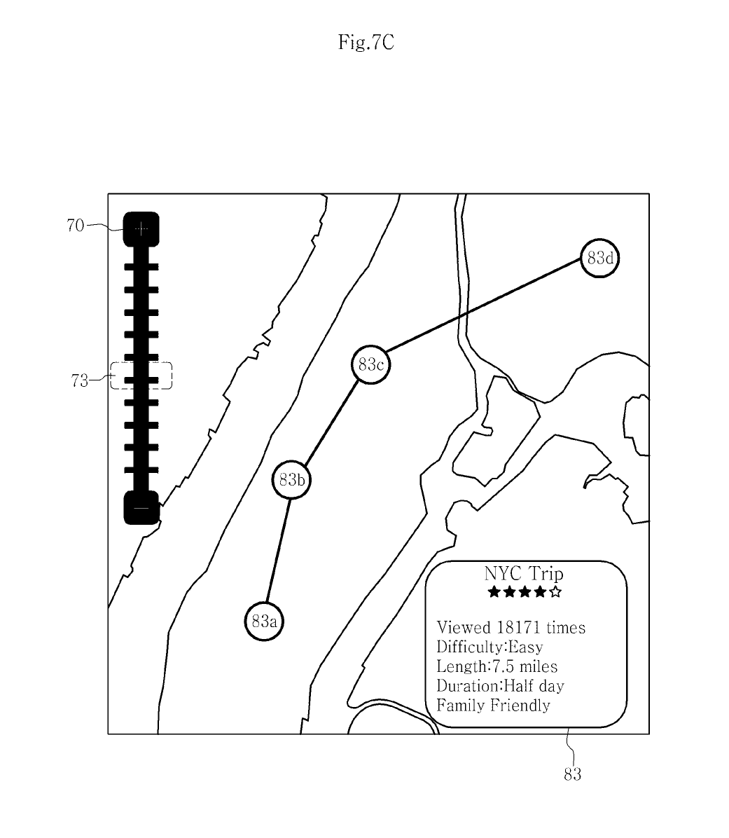

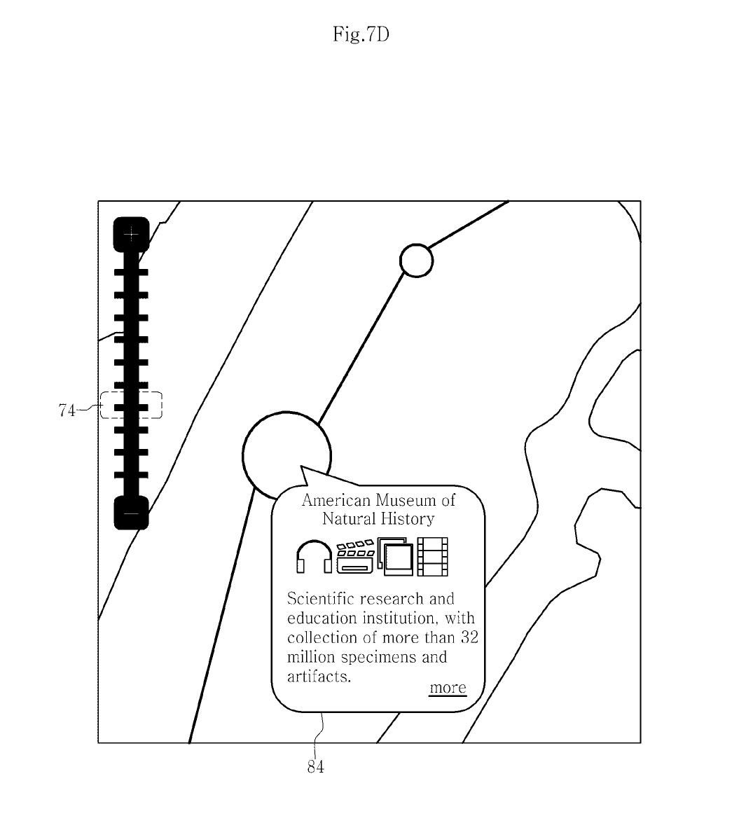

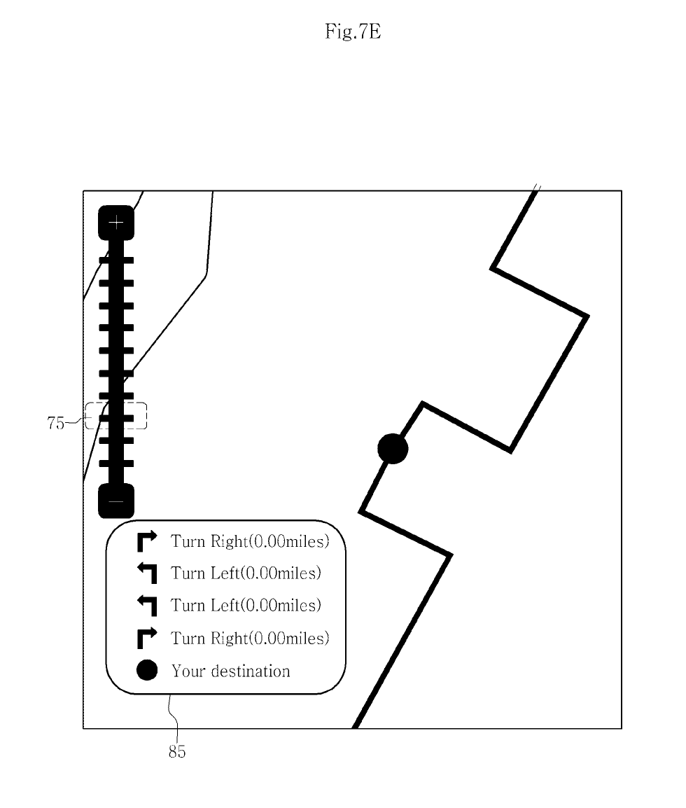

FIG. 7a illustrates an embodiment in which a content media displays appropriate content media information based on a LOD of a map, and shows an example of content media displayed on the display unit. Although one embodiment describes a travel content media, content media to which a LOD is applied is not limited to a travel content media.

An example in which a LOD of information of content media changes with a change in a zoom level 70 of a map by a user is shown. FIG. 7a shows that in the display at a highest level of granularity 71 where an outline summarized at a highest level is displayed, when a map shows countries or states by the unit of area, content media is displayed in a summarized format as a topic 81 of content (In FIG. 7a, a topic is ‘Alice's NYC trip’).

FIG. 7b illustrates an example of a zoomed-in map at a highest granularity. That is, a map at a second highest granularity 72 is displayed. Through the map, the content media also presents a summary 82 for content from the topic 81 of the content by displaying information about a narrow area in more detail than that at a highest granularity. When a granularity goes down to a desired level by a user zooming in a map, content media may be displayed through other content media that a content media includes, as shown in an example of FIG. 7c. That is, a content media may include other content media, and according to granularity, in the case of a highest granularity, content media is displayed as an upper-level content media including a lower-level content media, and in the case of a lowest granularity, included information is displayed in most detail using a lower-level content media. FIG. 7c illustrates an embodiment in which, when an upper-level content media has a lower-level content media, lower-level contents media 83a-83d representing a travel course are displayed in response to an increase in granularity (to 73 when compared to FIG. 7b), and the travel course includes content media of a next level of granularity and displays summary information 83 for content of the next level of granularity.

FIG. 7d shows, as an example of the content media at the low granularity of FIG. 7c (that is, at a scale 74), that information about a POI included in the travel course may be configured as content media 84 including all media including, for example, an audio, a video, and the like.

FIG. 7e shows a display at a lowest granularity 75 that may be configured as a granularity where all points on a course 85 for a travel are displayed.

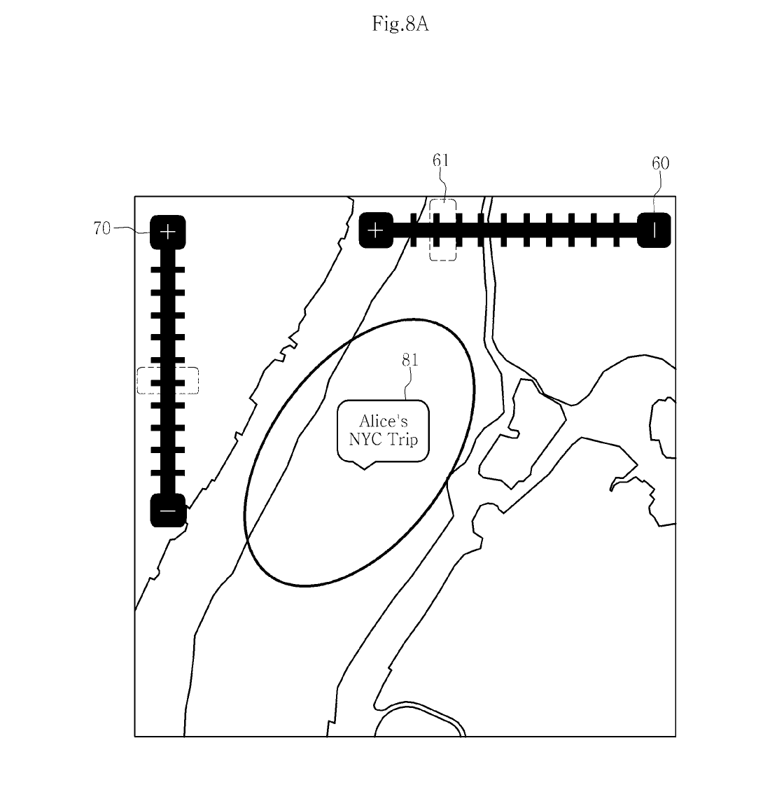

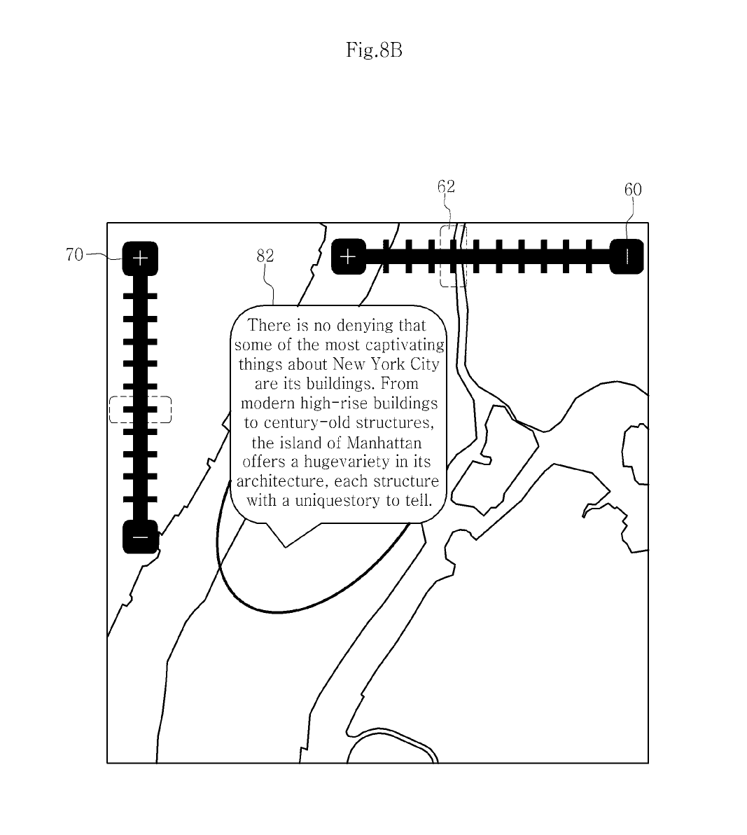

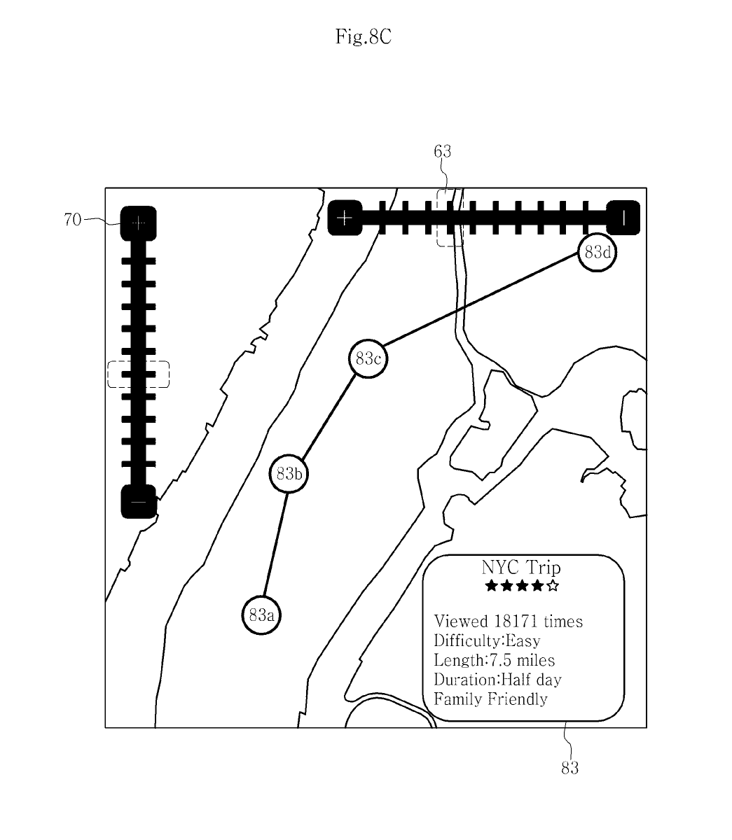

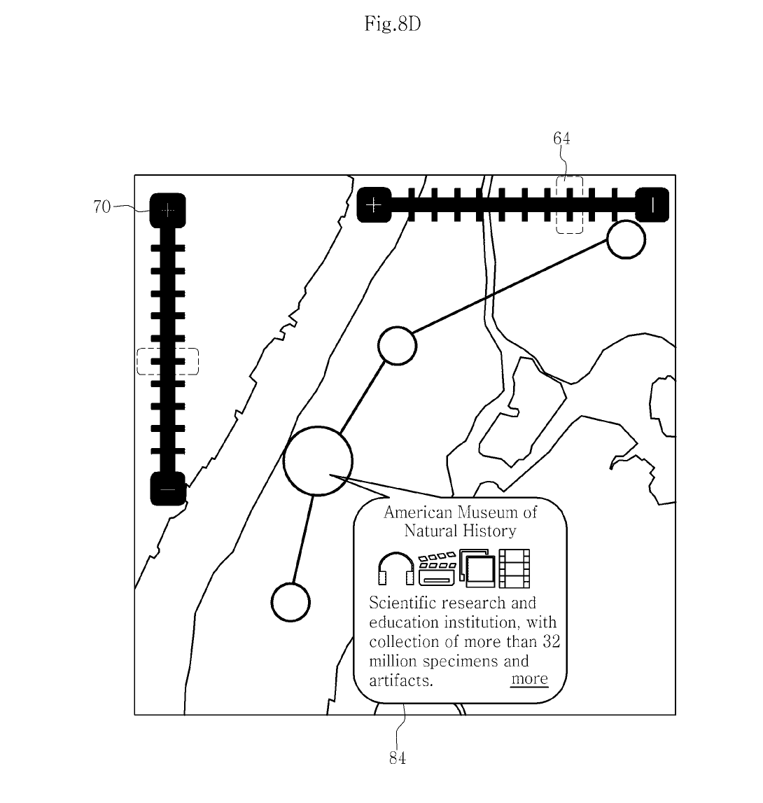

FIGS. 8a through 8e illustrate an embodiment in which content media has varying granularity based on a degree of interest of a user, and further to the embodiment of FIGS. 7a through 7e, an example of a representation method of a LOD of content media based on a degree of interest of a user at a fixed LOD of a map is shown.

Referring to FIGS. 8a through 8e, a bar 60 is disclosed that adjust a LOD of content media based on a LOD of context information of a user, independent of a LOD of a map. The bar 60 which adjusts a LOD is, as one embodiment for FIG. 6a, an example of a method for representing an information granularity on which an interest of the user in travel information is reflected. Also, the bar 60 which adjusts a LOD may determine an information granularity based on a level of interest of the user on the basis of, for example, FIG. 6b, and the level of interest of the user may be represented simultaneously or independently using only the bar 60 which adjusts a LOD or by selectively combining the bar 60 which adjusts various LODs, and an embodiment of the level of interest may be limited to the above embodiments.

The bar 60 of FIGS. 8a through 8e is different from the bar 70 which adjusts a scale of a map in FIGS. 7a through 7e, and may be displayed simultaneously with or independently from the bar 70. The user may adjust a display format of content media based on a LOD of user context information displayed by adjusting a setting point of the bar 60 from 61 to 65. Accordingly, even though a scale on a map is different, content media of the same format may be displayed by adjusting the bar 60. In other embodiment, a LOD of content media may be automatically determined based on a LOD of context information of a user.

The user may change the LOD of the map and the LOD of the user context information independently. FIGS. 8a through 8e show that the display of content media changes with a change in LOD of user context information at one LOD of a map.

That is, FIGS. 7a through 7e show the display of content media based on a scale of a map as content media. FIGS. 8a through 8e show the display of content media by LOD adjustment based on user context information at a fixed map scale.

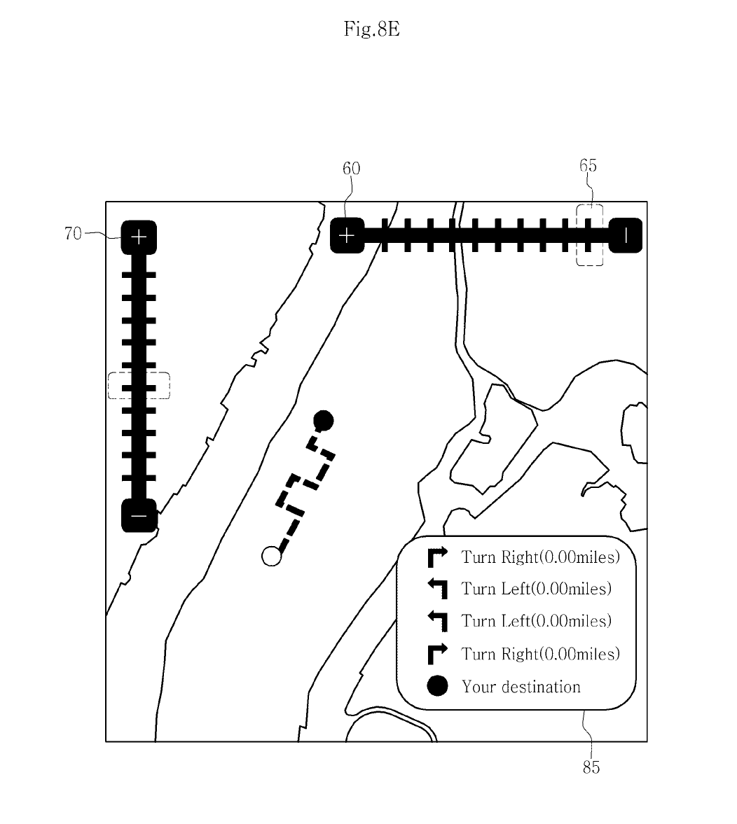

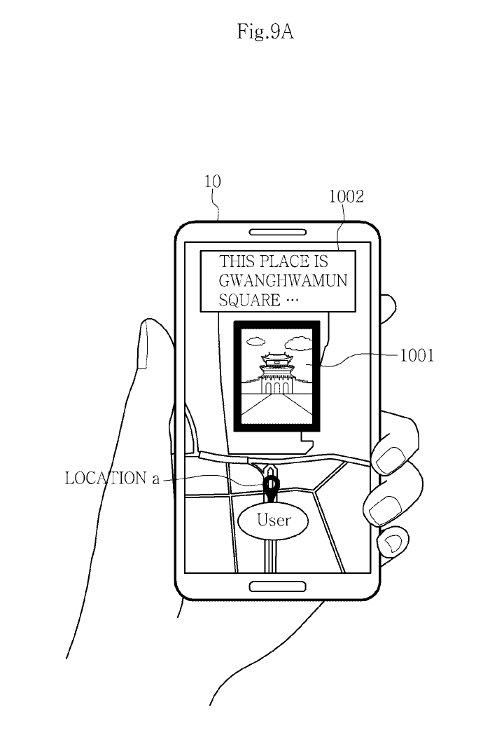

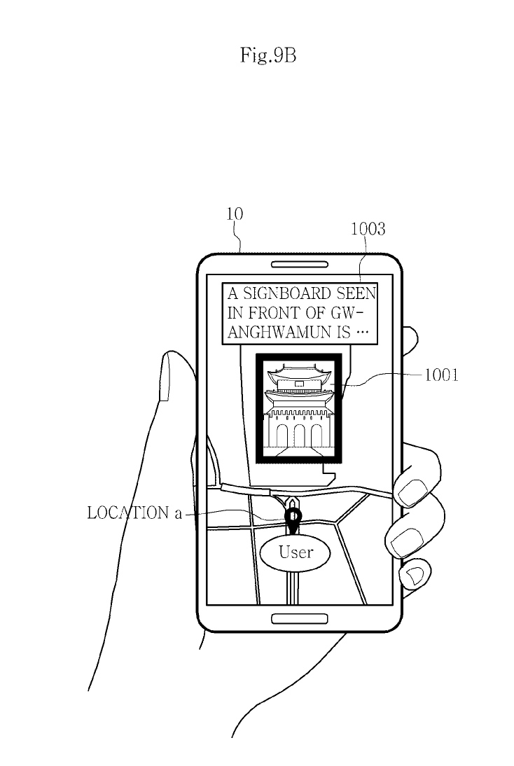

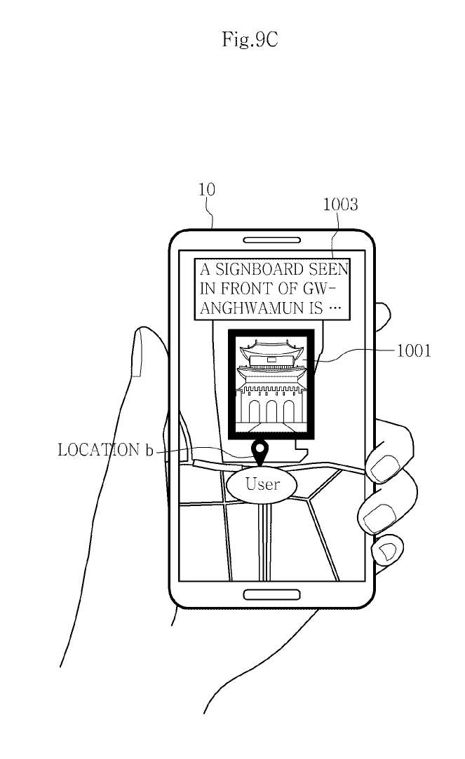

The display format determination unit 140 serves to determine a display format of a POI on content media based on LOD setting information. Also, the display format determination unit 140 serves to determine a display format of a POI based on display unit information of the client terminal 10. In one embodiment, when content media is a picture (FIG. 7a), the display format determination unit 140 may determine to display Gwanghwamun Square as a POI displayed on the whole display unit together with a text. FIG. 9a shows Gwanghwamun 1001 and information 1002 about Gwanghwamun as a text. In case LOD setting format is adjusted to display the Gwanghwamun 1001 included in the image of FIG. 9a in more detail enough to display a Gwanghwamun signboard (see FIG. 9b), the display format determination unit 140 determines a display format to display information 1003 about the signboard attached to the Gwanghwamun 1001 together in the detailed display.

Also, FIG. 9c illustrates an example in which a user does not adjust LOD setting information, and under the LOD setting condition as FIG. 9a, adjusts a LOD by moving in a direction facing the Gwanghwamun signboard, so that Gwanghwamun signboard is displayed on the display unit. That is, when the user moves from a location a to a location b, the display format determination unit 140 processes a display format of content media to allow the content media displayed on the display unit of the client terminal 10 to be transmitted to the user most properly.

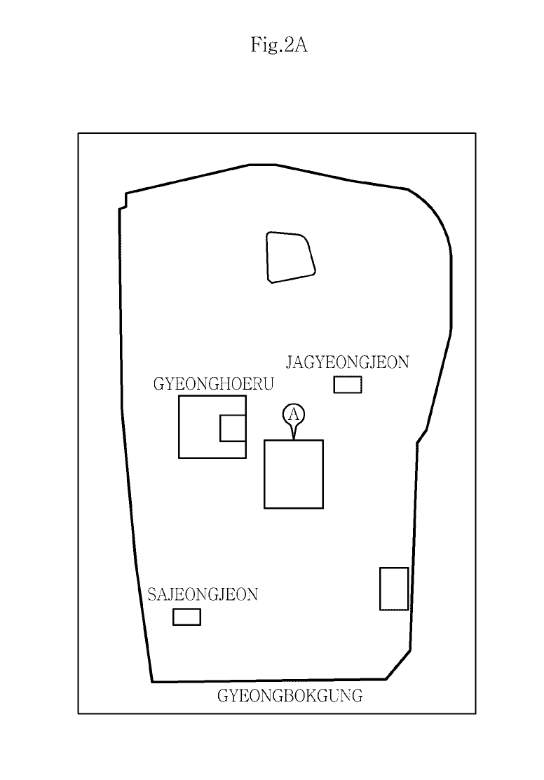

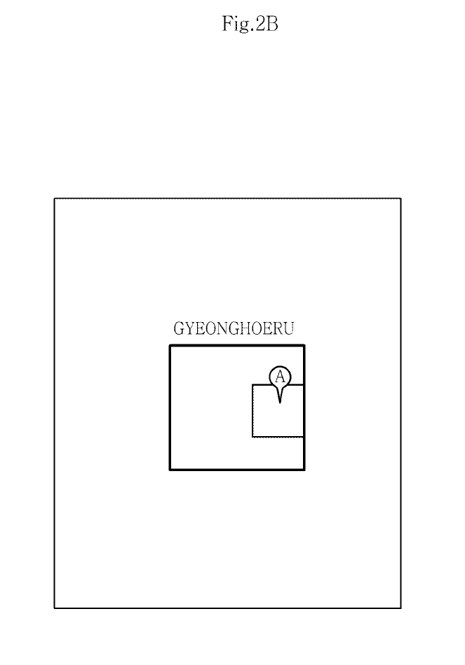

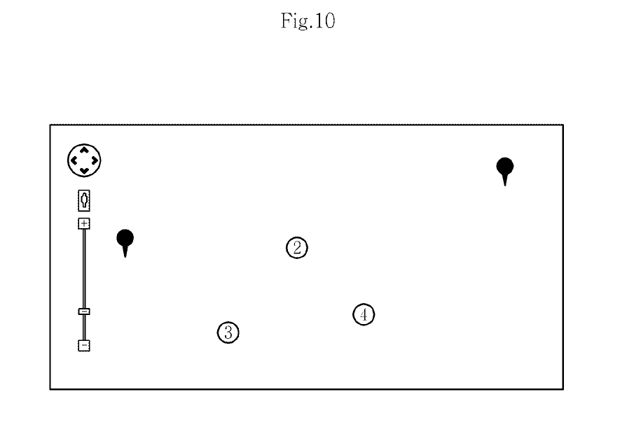

In one embodiment, the display format determination unit 140 serves to determine to display information about other POI that an area corresponding to a POI includes, based on LOD setting information. The client may identify content media, through the client terminal 10, in the format determined by the display format determination unit 140. Like FIGS. 2a and 2b, when Gyeongbokgung includes Gyeonghoeru, a POI or Gyeongbokgung is set to have information that Gyeongbokgung includes Gyeonghoeru as a lower-level POI, and when LOD setting information is high, the display format determination unit 140 omits a lower-level POI or displays a lower-level POI in a simpler manner. Also, in FIG. 10, a lower-level POI that an upper-level POI includes is represented in a form of a figure.

In another embodiment, the display format determination unit 140 determines a suitable granularity for the display format of the content media based on the LOD setting information, to enable the information granularity management unit 120 to display the content media at a proper granularity.

In still another embodiment, the display format determination unit 140 determines a suitable granularity for the display format of the content media based on the context of the user provided by the user context information management unit 170, to enable the information granularity management unit 120 to display the content media at a proper granularity.

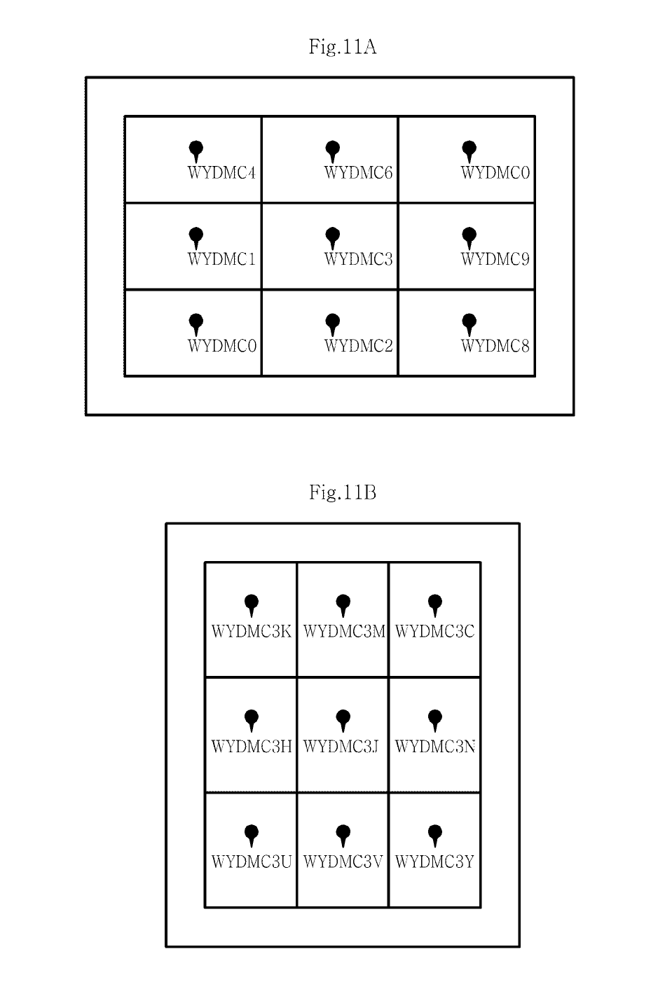

In one embodiment, the display format determination unit 140 may determine other POI that an area corresponding to a POI includes, through geohash information corresponding to the area corresponding to the POI. The geohash code is a system that represents a region on the Earth with a unique identification (ID) code of 32 letters. For example, a POI having WYDMC8 as geohash is an upper-level POI of a POI having WYDMC8A and WYDMC8B as geohash. For convenience of description, nine geohashes are presented in FIGS. 11a and 11b. FIG. 11a shows nine geohashes including WYDMC0, WYDMC1, WYDMC2, WYDMC3, WYDMC4, WYDMC6, WYDMC8, and WYDMCD. FIG. 11b shows nine geohashes including WYDMC3K, WYDMC3M, WYDMC3Q, WYDMC3H, WYDMC3J, WYDMC3N, WYDMC2U, WYDMC2V, and WYDMC2Y. In this instance, WYDMC3K, WYDMC3M, WYDMC3Q, WYDMC3H, WYDMC3J, WYDMC3N of FIG. 11a are subordinate geohashes of WYDMC3 of FIG. 11a, and WYDMC2U, WYDMC2V, WYDMC2Y of FIG. 11b are subordinate geohashes of WYDMC2.

The communication unit 150 serves to make a communication between the apparatus 100 for managing content media and the external object. The content media management unit 110, the information granularity information management unit 120, the display unit information management unit 130, the display format determination unit 140, and the user context information management unit 170 may communicate with the external object directly, but may make a communication with the external object in the support of the communication unit 150. A communication method may include all communication methods that enable networking between objects, and is not limited to wired/wireless communication, 3G, 4G, or other methods if it has a communication function.

The storage unit 160 serves to store internal information of the apparatus 100 for managing content media and various information received from the client terminal 10. Specifically, the storage unit 160 may store all information obtained during or after executing functions of the content media management unit 110, the information granularity information management unit 120, the display unit information management unit 130, the display format determination unit 140, and the user context information management unit 170.

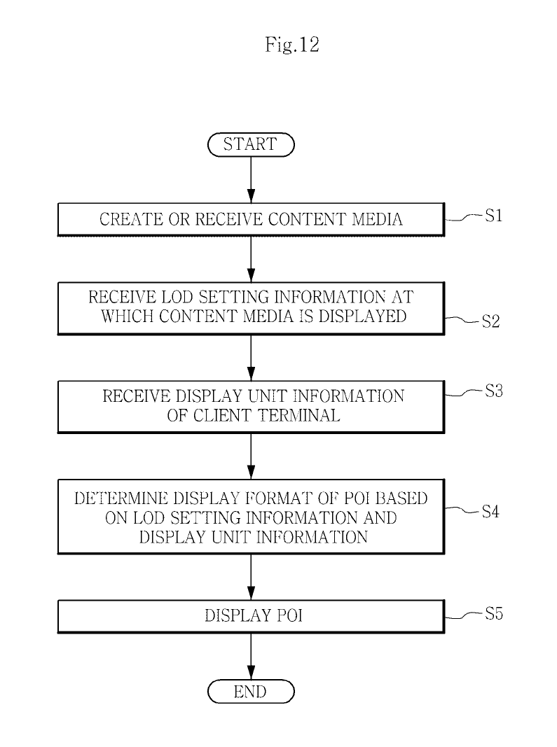

FIG. 12 is a flowchart illustrating a method for managing content media according to an exemplary embodiment. First, the apparatus 100 for managing content media creates content media or receives content media from an external object (51). The content media may include, but is not limited to, a map, an image, a video, and the like. The apparatus 100 for managing content media receives LOD setting information at which the content media is displayed (S2). In one embodiment, the apparatus 100 for managing content media may receive LOD setting information from the client terminal 10. Also, the apparatus 100 for managing content media receives display unit information of the client terminal from the client terminal (S3). The display unit information is information associated with a resolution and a horizontal size and a vertical size of the display unit on which the client terminal 10 is displayed. Subsequently, the apparatus 100 for managing content media determines a display format of a POI based on the LOD setting information and the display unit information (S4). In this process, the apparatus 100 for managing content media may determine other POI that an area corresponding to the POI includes, and determine a display format to allow the client terminal 10 to display this. The client terminal 10 displays the content media received through this process on the display unit, thereby transmitting a user experience to a user more efficiently (S5).

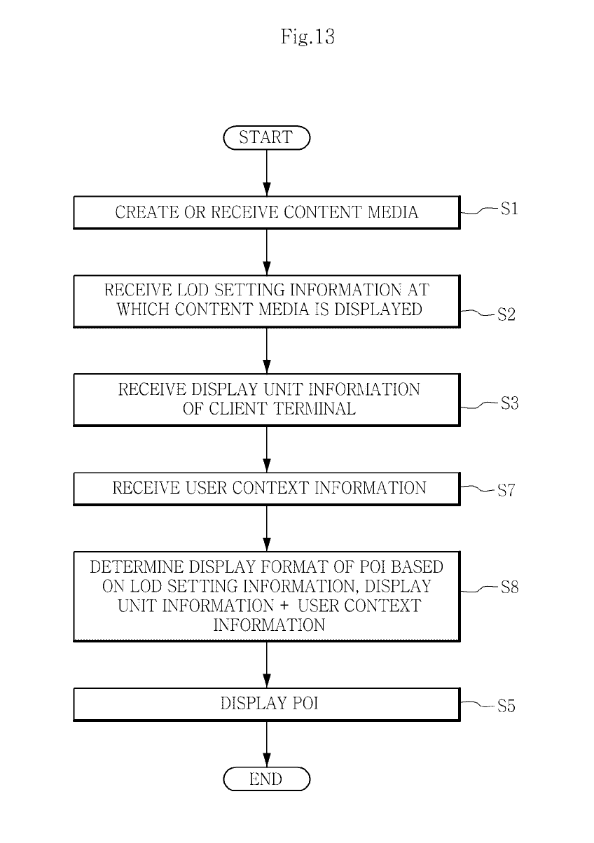

FIG. 13 is a flowchart illustrating a method for managing content media according to another exemplary embodiment. First, an apparatus 101 for managing content media creates content media or receives content media from an external object (S1). The content media may include, but is not limited to, a map, an image, a video, and the like. The apparatus 101 for managing content media receives LOD setting information at which the content media is displayed (S2). In one embodiment, the apparatus 101 for managing content media may receive LOD setting information from the client terminal 10. The apparatus 101 for managing content media receives display unit information of the client terminal from the client terminal (S3). The display unit information is information associated with a resolution and a horizontal size and a vertical size of the display unit on which the client terminal 10 is displayed. Also, the apparatus 101 for managing content media receives user context information including, for example, user location information, movement direction information, an experience history, and the like (S7). Subsequently, the apparatus 101 for managing content media determines a display format of a POI based on the LOD setting information, the display unit information, and the user context information (S8). In this process, the apparatus 101 for managing content media may determine other POI that an area corresponding to the POI includes, and determine a display format to allow the client terminal 10 to display this based on a granularity of the content media including a description of the POI. The client terminal 10 displays the content media received through this process on the display unit, thereby transmitting a user experience to a user more efficiently (S5).

The exemplary embodiments of the present disclosure described hereinabove may be embodied as a computer instruction executable through various computer components and recorded in computer-readable recording media. The computer-readable recording media may include a computer instruction, a data file, a data structure, and the like, singularly or in combination. The computer instruction recorded in the computer-readable recording media may be not only a computer instruction designed or configured specially for the present disclosure, but also a computer instruction available and known to those skilled in the field of computer software. The computer-readable recording media includes hardware devices specially configured to store and execute a computer instruction, for example, magnetic media such as hard disks, floppy disks, and magnetic tape, optical media such as CD ROM disks and digital video disc (DVD), magneto-optical media such as floptical disks, read-only memory (ROM), random access memory (RAM), flash memories, and the like. The computer instruction may include, for example, a high level language code executable by a computer using an interpreter or the like, as well as machine language code created by a compiler or the like. The hardware device may be configured to operate as at least one software module to perform processing according to the present disclosure, or vice versa.

Hereinabove, the present disclosure has been described by a particular disclosure such as a specific component and limited exemplary embodiments and drawings, but this is just for the purpose of helping provide a better understanding of the present disclosure, the present disclosure is not limited by the exemplary embodiments, and various modifications and changes may be made from the disclosure herein by those skilled in the art.

Therefore, the scope of the present disclosure is not defined by the exemplary embodiments disclosed herein, and the appended claims and all differences within the equivalent scope thereto will be construed as being included in the present disclosure.

What is claimed is:

1. A method for managing content media, comprising:
creating or receiving content media;
receiving level of detail (LOD) setting information at which the content media is displayed; and
determining a display format of information about a point of interest (POI) on the content media based on the LOD setting information.

2. The method for managing content media according to claim 1, wherein the receiving of the LOD setting information at which the content media is displayed further comprises receiving display unit information of a client terminal from the client terminal, and
the determining of the display format of the P01 on the content media further comprises determining the display format of the information about the P01 on the content media further based on the display unit information of the client terminal.

3. The method for managing content media according to claim 1, wherein the determining of the display format of the POI on the content media further comprises determining the display format of the information about the POI on the content media further based on user context information.

4. The method for managing content media according to claim 1, wherein the receiving of the LOD setting information at which the content media is displayed further comprises receiving the LOD setting information at which the content media is displayed, from a client terminal.

5. The method for managing content media according to claim 1, wherein the determining of the display format of the POI on the content media based on the LOD setting information further comprises determining to display information about other POI that an area corresponding to the POI includes, based on the LOD setting information.

6. The method for managing content media according to claim 5, wherein the determining to display the information about other POI that the area corresponding to the POI includes based on the LOD setting information further comprises determining other POI that the area corresponding to the POI includes, through geohash information corresponding to the area corresponding to the POI.

7. A computer-readable recording medium having stored therein a program for causing a computer to execute a method for managing content media comprising creating or receiving content media, receiving level of detail (LOD) setting information at which the content media is displayed, and displaying information about a point of interest (POI) on the content media based on the LOD setting information.

8. An apparatus for managing content media, comprising:
a content media management unit to create or receive content media;
an information granularity management unit to receive level of detail (LOD) setting information at which the content media is displayed; and
a display format determination unit to determine a display format of information about a point of interest (POI) on the content media based on the LOD setting information.

9. The apparatus for managing content media according to claim 8, further comprising:
a display unit information management unit to receive display unit information of a client terminal from the client terminal,
wherein the display format determination unit determines the display format of the information about the POI on the content media further based on the display unit information of the client terminal.

10. The apparatus for managing content media according to claim 8, wherein the information granularity management unit receives the LOD setting information at which the content media is displayed, from a client terminal.

11. The apparatus for managing content media according to claim 8, wherein the information granularity management unit determines to display information about other POI that an area corresponding to the POI includes, based on the LOD setting information.

12. The apparatus for managing content media according to claim 11, wherein the information granularity management unit determines other POI that the area corresponding to the POI includes, through geohash information corresponding to the area corresponding to the POI.

13. The apparatus for managing content media according to claim 8, wherein the information granularity management unit further comprises a user context information management unit to receive user context information, and determines the display format of the information about the POI on the content media further based on the user context information.
